(19) United States
(12) Patent Application Publication
(10) Pub. No.: US 2011/0204825 A1
(43) Pub. Date: Aug. 25, 2011

(54) Light stick with a dazzling effect

(76) Inventors: Wei Hung Yu, Irvine, CA (US); Connie Wang, Irvine, CA (US)

(21) Appl. No.: 12/656,954

(22) Filed: Feb. 22, 2010

(51) Int. Cl. H05B 39/00

(52) U.S. Cl. 315/313

(57) ABSTRACT

This invention is a light stick with a dazzling effect, comprising a handle, a dazzle layer and a transparent tube; on the upper part of the handle there is an illuminated body with a number of light-emitting diodes (LEDs); the body of the handle has a battery and a number of on/off switch; the dazzle layer is fitted inside the transparent tube which is then placed over the illuminated body, then joined together with the handle; in this way a light stick with a changing dazzling effect is provided.

### BACKGROUND OF THE INVENTION

1. Field of the Invention

This invention relates to a light stick with a dazzling effect created with a sparkling Polyvinyl chloride (PVC) paper, specifically one with a transparent film in which the film can be color printed (pad printed, silk screened, laser or hologram paper, etc.) between the illuminated body and transparent tube on the handle, gives this light stick a spectacular dazzling effect.

2. Description of the Prior Art

Light sticks are often used during mass gatherings such as being waved by fans at sporting events or concerts. These light sticks create a special lighting effect amongst the crowd, adding to the excitement of the event.

Most traditional light sticks have a switch that is used to control the light pattern to the illuminated body to create light, furthermore, on this type of light stick, no matter what kind of light part is used on the light source end, the display end can only be one simple shape, cylindrical for example, meaning that light sticks can only be cylindrical illuminated or flickering sticks and cannot show colorful light patterns.

Different color illuminated bodies can be used to compensate for this shortcoming, however, the cylindrical shape cannot be changed, thus the special effect of a light stick cannot be fully brought into play. This shortcoming is common amongst conventional light sticks.

### SUMMARY OF THE INVENTION

The objective of this invention is to provide a new generation light stick which has a transparent film between the illuminated body and the transparent tube that makes the light source of the illuminated body create a special dazzling visual effect.

The handle of this invention has a battery, a circuit board and an open end illuminated body inside. The outside of the handle has a power supply switch and/or a manual switch that is used to turn the light of the illuminated body on and off, change the color of the light patterns and flicker frequency, making it easy to use and providing diverse light changes.

### BRIEF DESCRIPTION OF DRAWINGS

This invention will be better understood by referring to the accompanying drawings, wherein:

FIG. 1 is an exploded perspective view of a preferred embodiment of the light stick with a dazzling effect in the present invention;

FIG. 2 is a perspective view of a preferred embodiment of the light stick with a dazzling effect in the present invention;

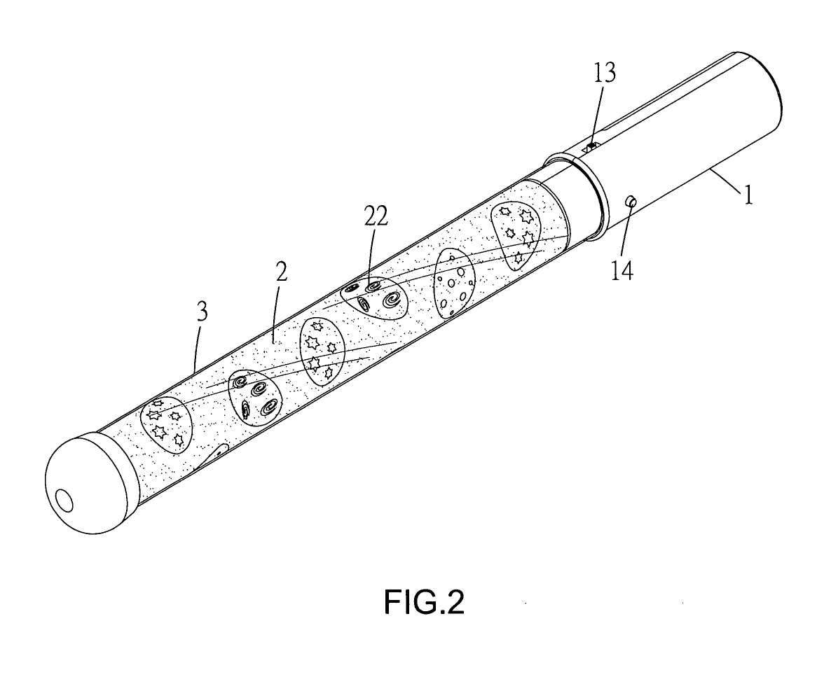

FIG. 3 is an exploded perspective view of the transparent film in the present invention;

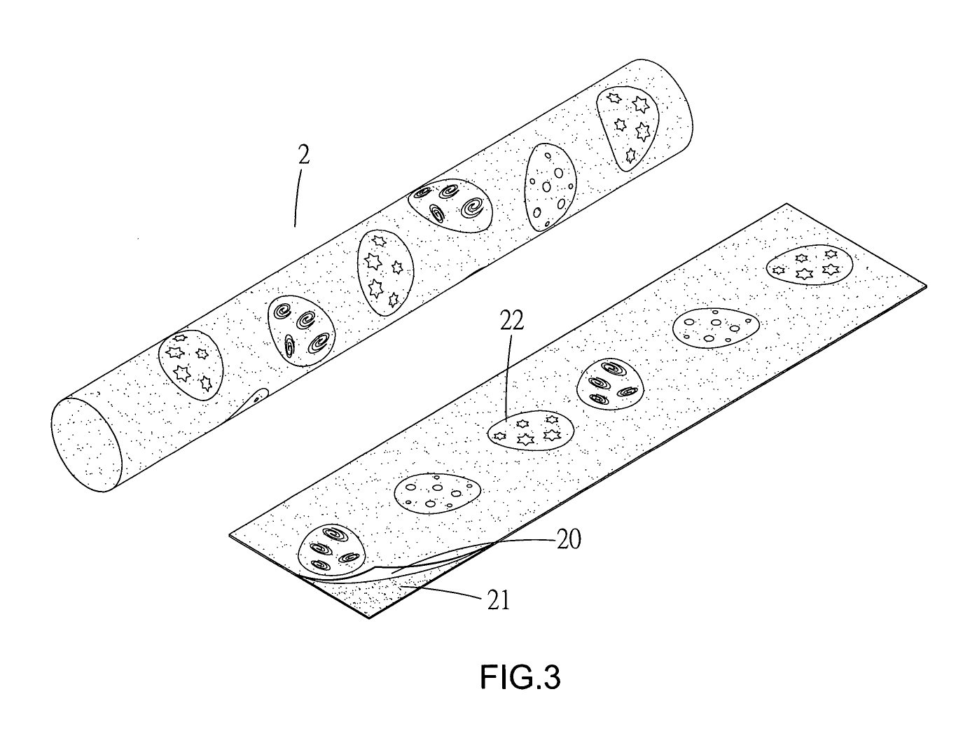

FIG. 4 is a perspective view of another the patterns in the present invention;

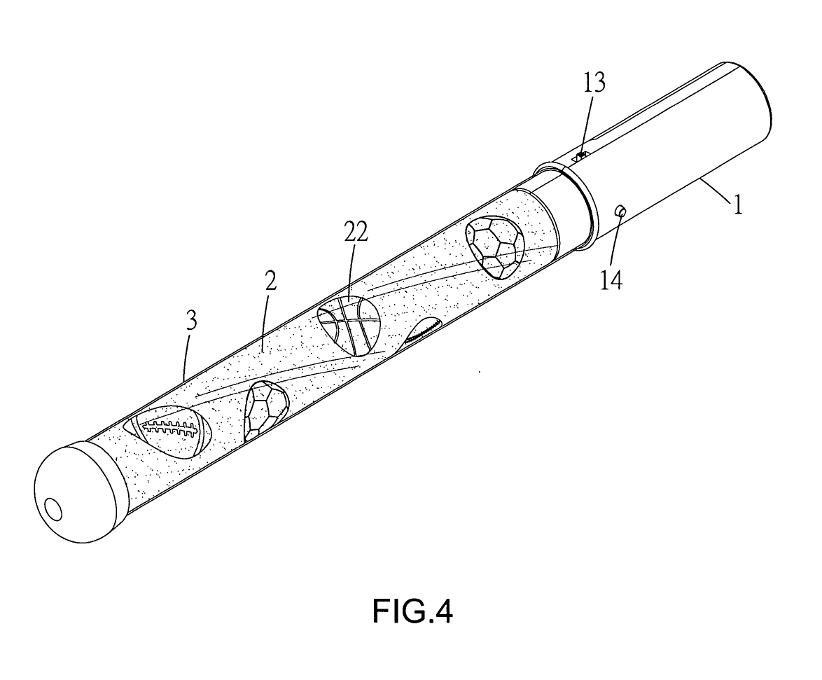

FIG. 5 is a perspective view of another actual embodiment of the light stick with a dazzling effect in the present invention; and

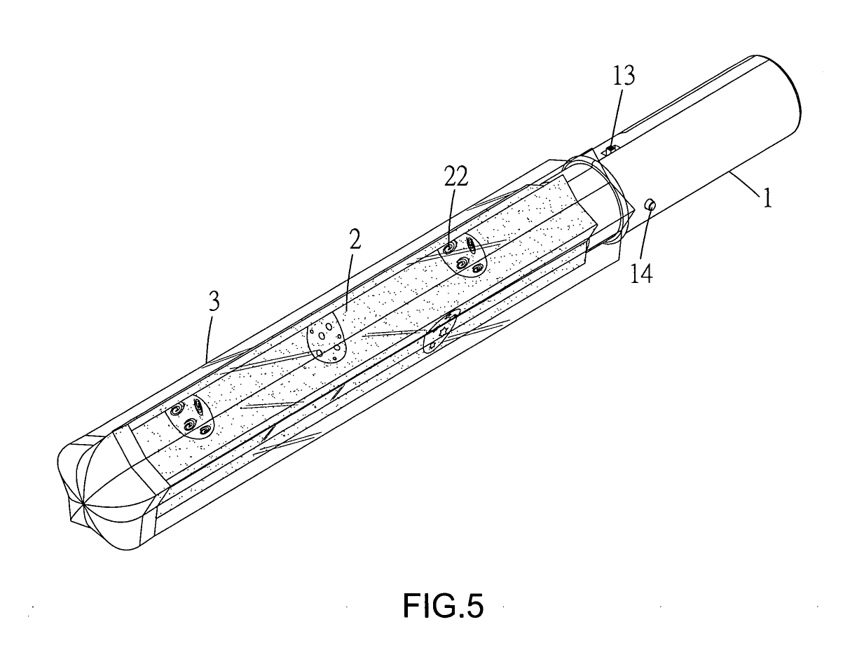

FIG. 6 is a perspective view of another actual embodiment of the light stick with a dazzling effect in the present invention.

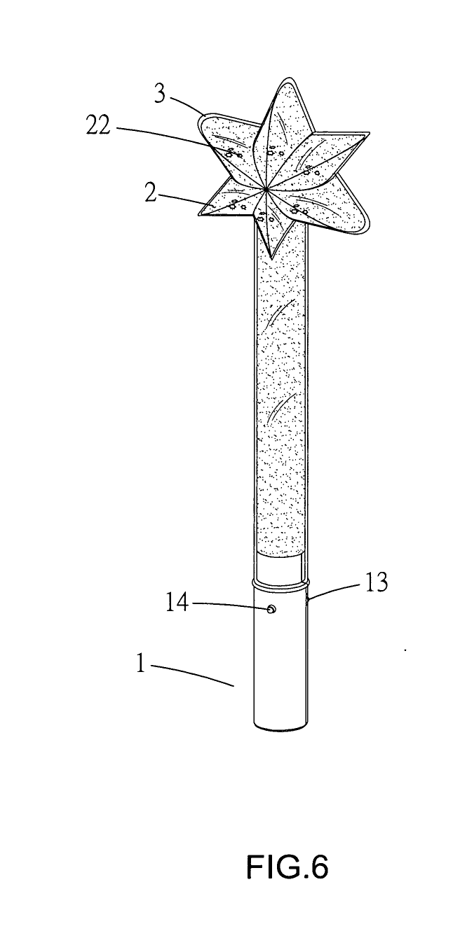

### DETAILED DESCRIPTION OF THE PREFERRED EMBODIMENT

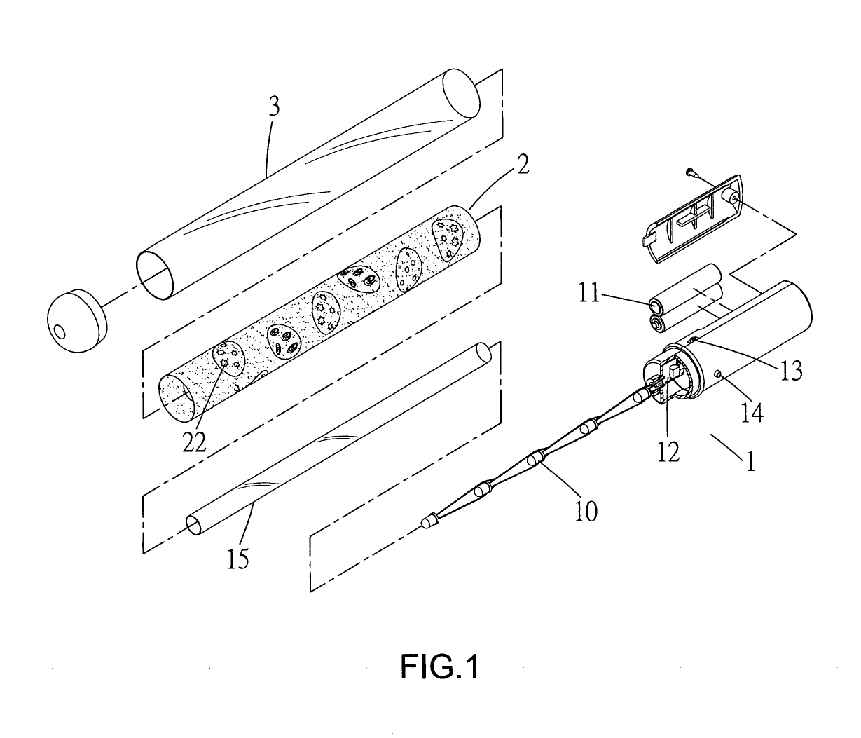

As shown in FIGS. 1˜6, a preferred embodiment of the present invention includes a handle 1, a transparent film 2 and transparent tube 3. The transparent tube 3 can be also be translucent.

On the upper part of the handle 1 is illuminated body 10 comprising of a number of light-emitting diodes (LEDs); inside the hollow handle 1 are a battery 11, and a circuit board 12. The switch 13 and a manual switch 14 are on the outer wall of the handle 1, and control the flow of electricity from the battery 11 to the illuminated body 10 through circuit board 12. There is a transparent tube 15 on the illuminated body 10.

The transparent film 2 is fitted on the outside of illuminated body 10 on handle 1; the transparent film 2 is comprised of processed Polyvinyl chloride (PVC) paper 20, a dazzle layer 21 and patterns 22. The dazzle layer 21 is attached under Polyvinyl chloride (PVC) paper 20 while pattern 22 is attached on top of Polyvinyl chloride (PVC) paper 20. The Polyvinyl chloride (PVC) paper 20 can be made from Polyurethane (PU), Oriented Polypropylene (OPP), Polyethylene (PE) etc., and the patterns can be single or multi colored.

The transparent tube 3 is fixed on the handle 1 and covers the illuminated body 10 and the transparent film 2.

When the dazzle light stick is assembled the transparent film 2 is first inserted into the transparent tube 3, then transparent tube 3 is fitted over the illuminated body 10 and fixed to handle 1, allowing easy assembly.

When used, when the switch 13 is pushed, illuminated body 10 produces different light rays and different flickering frequencies. In combination with the dazzle layer 21 in the transparent film 2 and different 3D patterns 22, the light stick produces special light effects and achieves the aforementioned objectives. To turn the power source off, all that is needed is that the switch 13 be pushed. Likewise, when manual switch 14 is pressed down, power is supplied to illuminated body 10, causing the light to flicker. When the manual switch 14 is released, the power source is automatically turned off.

The preferred embodiment described above is only intended to illustrate this invention and in manufacturing illuminated body 10 can be controlled by various circuit boards 12 and produce different luminous frequencies and the pattern 22 on the transparent film 2 can be different 3D patterns according to need, offering more variety.

While the preferred embodiment of the invention has been described above, it will be recognized and understood that various modifications may be made therein and the appended claims are intended to cover all such modifications that may fall within the spirit and scope of the invention.

What is claimed is:

1. A light stick with a dazzling effect, including:
a handle that is hollow and in which there is a battery, a circuit board and a module with an illuminated body; a switch and manual switch are on the outer wall of the handle and controls the light patterns through the circuit board to the illuminated body;
a transparent tube attached to the open end of the handle and the transparent tube is hollow;
characterized between the handle's illuminated body and transparent tube is a transparent film, comprising of Polyvinyl chloride (PVC) paper, a dazzle layer and patterns; and
the effect of the transparent film causes the illuminated body's light source to flicker and the patterns to change, providing a light body with an enhanced effect.

2. A light stick with a dazzling effect as claimed in claim 1, wherein the illuminated body can be two or more light-emitting diodes (LEDs) and can be one or more different colors.

3. A light stick with a dazzling effect as claimed in claim 1, wherein the Polyvinyl chloride (PVC) paper of the transparent film can be replaced by Polyurethane (PU), Oriented Polypropylene (OPP), Polyethylene (PE) etc., to give a semi transparent latex.

4. A light stick with a dazzling effect as claimed in claim 2, wherein more than two light-emitting diodes (LEDs) can use different patterns or different/the same colors to achieve the best visual effect.

5. A light stick with a dazzling effect as claimed in claim 1, wherein the shape of the transplant tube can be transparent, translucent or any colored cylindrical, square or other 3D shape.
